(19) United States
(12) Patent Application Publication
(10) Pub. No.: US 2011/0054974 A1
(43) Pub. Date: Mar. 3, 2011

(54) ALLOCATION OF RESOURCES ACROSS AN ENTERPRISE

(75) Inventors: CHRISTINE BOBST, NORWALK, IA (US); ANTONIO M. ESMERALDO, ELDORAIGN CENTURION (ZA); FRANCI PHELAN, MAXWELL, IA (US); ROMAN KUGLER, SAVOSA (CH)

(73) Assignee: PIONEER HI-BRED INTERNATIONAL, INC., JOHNSTON, IA (US)

(21) Appl. No.: 12/551,681

(22) Filed: Sep. 1, 2009

(51) Int. Cl. G06Q 10/00

(52) U.S. Cl. 705/8; 705/7; 705/11

(57) ABSTRACT

A computer-assisted method provides for allocating resources across an enterprise to match needs for different business units across the enterprise. The method includes defining business unit categories in a software system. Each of the business unit categories includes a plurality of business factors. The method further includes collecting data associated with the business factors and defining the service levels in the software system. The method further includes forming an impact matrix to relate the service levels to the business factors and analyzing the impact matrix using the software system to provide an analysis to assist in allocating resources.

### FIELD OF THE INVENTION

The present invention relates to the allocation of resources in an enterprise. More specifically, the present invention relates to computer assisted methods and computerized systems for collecting and analyzing data which assists in the allocation of resources across the enterprise.

### BACKGROUND

Large enterprises typically include a number of different business units which may be organized or defined by function, location or both. One problem with large enterprises is the ability to allocate resources appropriately across numerous business units. This basic problem can occur regardless of the type of enterprise or the function of the different business units.

For example, consider the allocation of human resources across a global enterprise engaged in the life sciences industry. Numerous challenges may present themselves to human resources personnel. They challenges may include: availability of multiple skill levels and associated labor and diversity within the labor force; turnover and or the retention of staff; location attractiveness; seasonal considerations; presence and bargaining power of unions or work councils; stability of different governments and their legal frameworks; issues related to the number of separate countries and their respective languages, ethical and cultural complexity; number of products or product types and associated technology and marketing. Addressing these and other challenges requires sufficient resources, yet determining the amount of resources and types of resources required is elusive. Thus, efficient and effective allocation of resources is a difficult problem to address

Of course these and other similar problems may be encountered in other types of enterprises and for allocation of resources other than those associated with human resources. What is needed is a way to quantify resource needs to assist in the allocation of resources across an enterprise.

### BRIEF SUMMARY

A computer-assisted method for allocating resources across an enterprise to match needs for different business units across the enterprise. The method comprises defining business unit categories in a software system, wherein each of the business unit categories includes a plurality of business factors. Collecting data associated with the business factors. Defining the service levels in the software system. Forming an impact matrix to relate the service levels to the business factors. Analyzing the impact matrix using the software system to provide an analysis to assist in allocating resources, wherein the software system is executed on a computer.

An article of software stored on a computer readable medium and adapted for being executed on a computer to assist in allocating resources across an enterprise, the article of software adapted for: (1) defining business unit categories in a software system, each of the business unit categories including one or more business factors, (2) collecting data associated with the business factors, (3) defining service levels for the business factors, (4) forming an impact matrix to relate the service levels to the business factors, and (5) analyzing the impact matrix to provide an analysis to assist in allocating resources.

A computer-assisted method for allocating resources associated with Human Resources across an enterprise. The method comprises defining business unit categories associated with providing Human Resources to the enterprise and each of the business unit categories includes one or more business factors. Wherein the business unit categories comprise at least one of market complexity, market size, and market life cycle. Collecting data associated with the business factors, wherein the data comprises financial data and employment data. Defining service levels in the software system for the business factors by applying a scoring system to the service levels for the business factors. Forming an impact matrix to relate the service levels to the business factors; and analyzing the impact matrix using a software system to provide a gap analysis to assist in allocating the resources, wherein the software system being executed on a computer.

### BRIEF DESCRIPTION OF THE DRAWINGS

FIG. 1 is a flow chart providing an overview of one example of a method and system.

FIG. 2 is a flow chart of the computer-assisted method.

FIG. 3 is a screen display associated with a business unit size category.

FIG. 4 is a diagram associated with business complexity.

FIG. 5 is a chart showing the human resource core areas as they relate to core functions and processes.

FIG. 6 relates size of a business unit and core functions to service levels.

FIG. 7 relates life cycle of a business unit and core functions to service levels.

FIG. 8 is an impact matrix comparing business unit complexity to human resource core functions.

FIG. 9 is an impact matrix impact comparing a country to human resource core functions.

FIG. 10 is a chart showing a GAP analysis page as can be created by the computer software application based on GAP analysis concepts.

FIG. 11 is an overview page of the service level design.

FIG. 12 is an impact matrix overview comparing human resource core services to business factors.

### DETAILED DESCRIPTION

### Overview

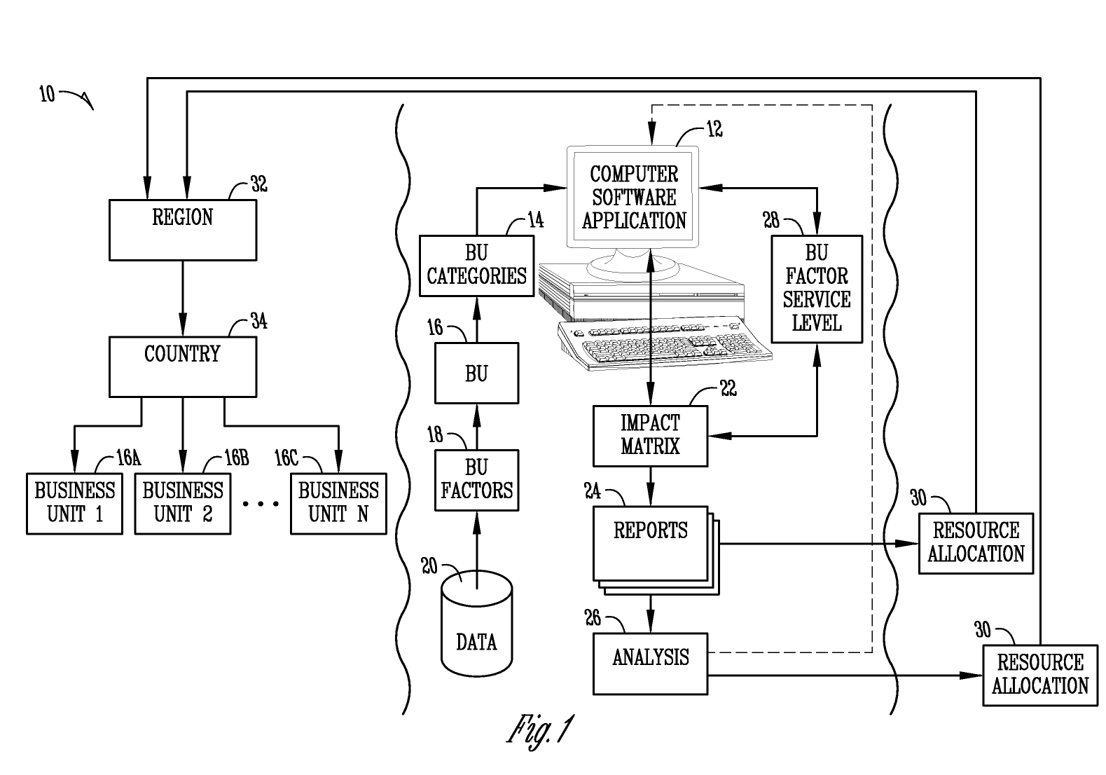

FIG. 1 provides an overview of a computer-assisted method and system 10 for allocating human resources across an enterprise to match needs for different business units across the enterprise. A computer software application 12 executing on a computing device accepts data 20 related to specific business factors 18 for a plurality of business units 16. The data 20 may include such data as the number of employees, the number of seasonal employees, revenue, sales data, and other information.

The plurality of business units 16 are filtered through a plurality of business unit categories 14. Each business unit 16 also has predetermined service levels 28 which are entered into the computer software application 12. The computer software application 12 merges the data 20 and service levels 28 into an impact matrix 22. Reports 24 generated from the impact matrix 22 may be analyzed 26 by using GAP analysis or other types of analysis. Based on the reports 24 and analysis 26, resource allocation 30 can be performed more accurately and efficiently across a plurality of regions 32, a plurality of countries 34 and across business units 16A, 16B, and 16C.

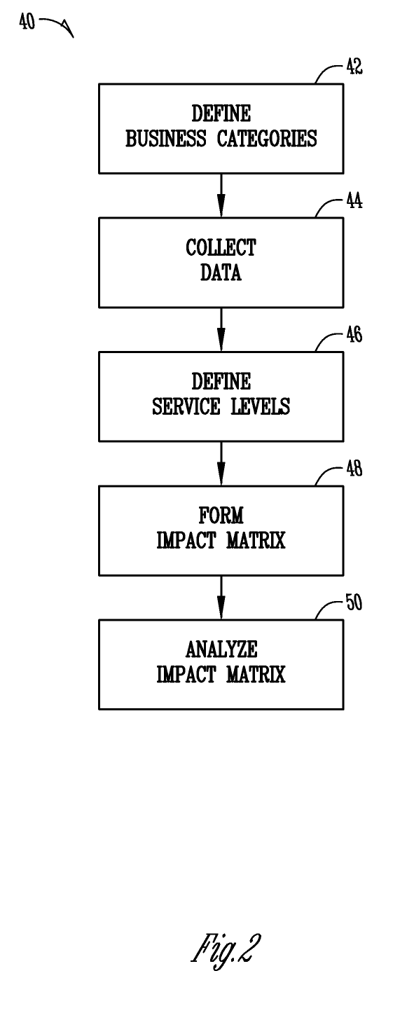

FIG. 2 provides a flow chart of the computer-assisted method. The first step for the computer-assisted method 40 is to define business categories 42. Any number of business categories may be defined. Next in step 44, data is collected. In step 46, service levels are defined. In step 48, an impact matrix is formed. In step 50, the impact matrix is analyzed. Although the steps shown in FIG. 2 are in a particular order, what is shown is merely one example of an ordering of steps. It is to be appreciated, for example, that the service levels may be defined before the data is collected, or these steps may be performed at the same time.

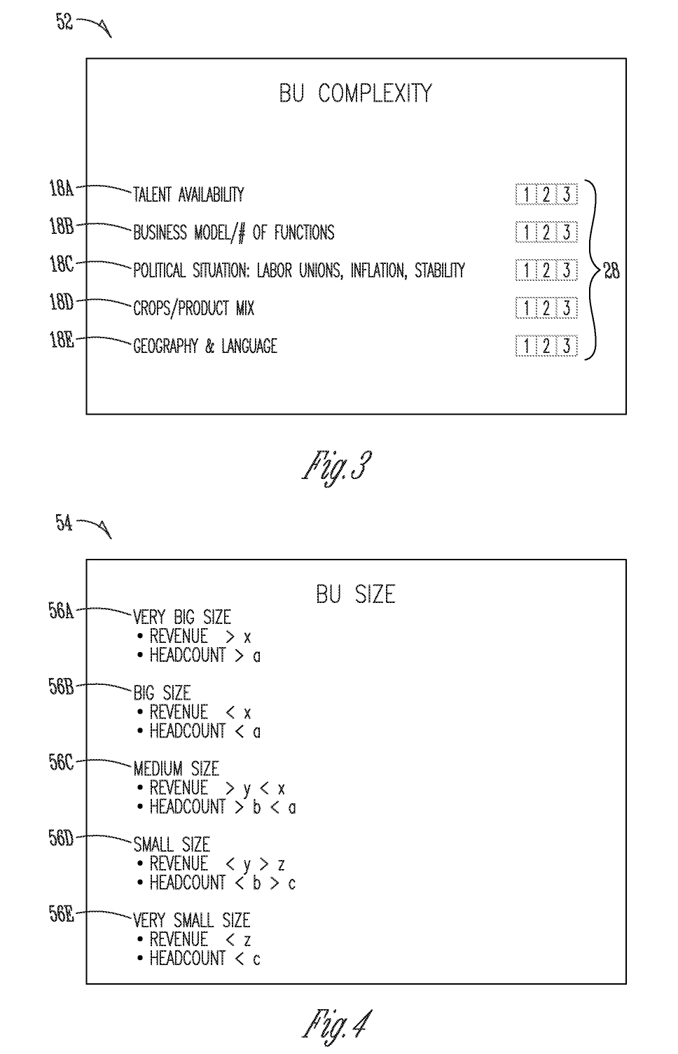

Different business units may require different human resources service levels. To assist in characterizing the requirements for different business units, business unit categories are established. Any number of business categories can be used. One example of a business unit category is business unit size. FIG. 3 provides a screen display associated with a business unit size category. Business unit size may be described in various ways. As shown in FIG. 3, business unit size is characterized by both revenue and headcount. A “very big size” business unit 56A has revenue larger than x and headcounts greater than a. A “big size” business unit 56B has revenue less than x and headcounts less than a. A “medium size” business unit 56C has revenue greater than y and less than x, and headcounts greater than b and less than a. A “small size” business unit 56D has revenue greater than z and less than y and headcounts greater than c and less than b. A “very small size” business unit 56E has revenue less than z and headcounts less than c. The values for variables x, y, z, a, b, and c can be whatever fits a specific organization's requirements. In addition, other measures may be used in calculating business unit size.

Another example of a category is business unit complexity. Business unit complexity may include a number of business factors related to complexity. FIG. 4 provides a screen display associated with the collection of data regarding business unit complexity. Business unit complexity 52 may be described through use of a number of different business factors. Examples of such factors may include talent availability 18A, business model/number of functions 18B, political situation 18C, product mix 18D, and geography and language 18E and their inter-relationships. Talent availability factor 18A may relate to the skills and/or labor needed, diversity of staff, turnover and/or retention of staff, and location attractiveness. Note that each of these factors may have a corresponding score 28 such as a score from 1 to 3 as shown in FIG. 4. The scores 28 are associated with a particular service level. Service levels are a measure of resources provided to or allocated to a business unit due to the business factors associated with the business unit. The use of service levels is described in greater detail later herein.

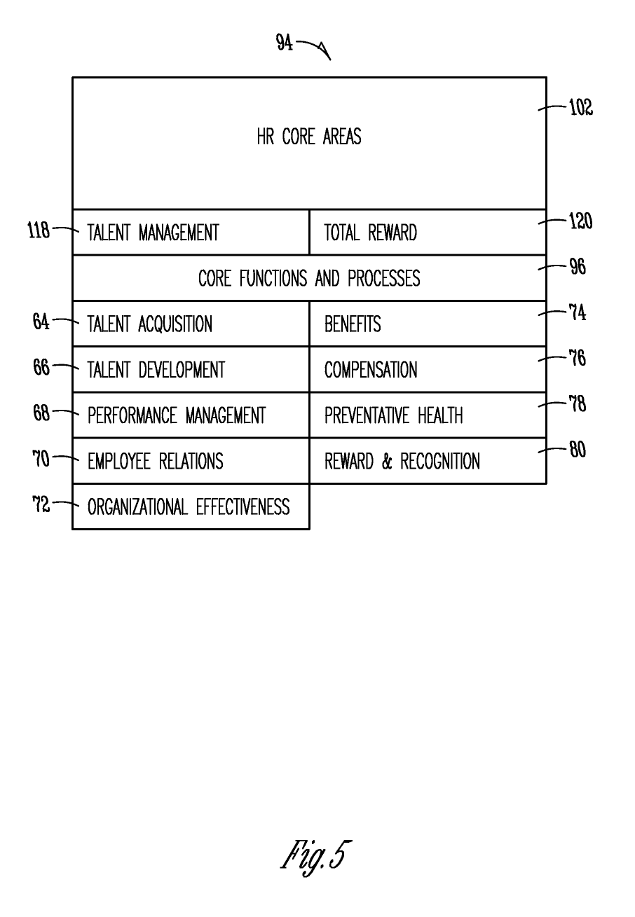

To understand how service levels can be used to describe resources, consider how the operations of the business unit can be described through identifying core areas as well as related core functions and processes. FIG. 5 is a chart showing the human resource core areas as they relate to core functions and processes. Service levels may be designed around human resources core areas 94, as shown in FIG. 5. The human resource core areas 94 may include talent management 118, total rewards 120, and service delivery 122. Each core function may have a related process. Each process may also have a related sub-process. Service level design criteria are assigned to the core functions through the development of the related processes. For example, each process and related sub-process may be assigned a level of 1 to 3. Whereby service level 1 is basic or foundational, service level 2 is intermediate, and service level 3 is advanced. A detailed service level catalog or database may be used to store values for analysis. Note that although levels 1 to 3 are used throughout, this is merely one example of a range of service levels which may be defined. Instead, different scales for assigning service levels may be assigned, including but not limited to scales of 1 to 4, 1 to 5, 1 to 10, or 1 to 100. In addition, the numbers assigned need not be integer values but may be real numbers instead.

The specific core areas, core functions, and processes may depend upon the type of enterprise, the type of resources being allocated, and other considerations. As shown in FIG. 5, the human resource core area talent management 118 is a first core area and may include the human resource core functions of talent acquisition 64, talent development 66, performance management 68, employee relations 70, and organizational effectiveness 72. The human resource core area total reward 120 may include human resource core functions such as benefits 74, compensation 76, preventative health 78, and reward and recognition 80. Benefits 74 is a core function which may multiple processes. Examples of such processes may include: design and administration; severance; relocation; and pension. Processes severance, relocation, and, pension may have only one service level.

Each of the core functions may include any number of associated processes. For example, talent acquisition 64 is a core function with processes which may include: assessment and selection; diversity and affirmative action; workforce planning; new employee orientation and on-boarding; employment branding; interviewing, applicant tracking, pre-employment testing, background checks, personality assessment; and recruitment. Applicant tracking and interviewing may be sub-processes under the assessment and selection process.

Talent development 66 is a core function with various processes. The processes may include: team development; employee development individual contributor development; people/process leader development; business/functional leader development; supervisory development; leadership development; succession management; career development; competency model, process, tools for core and business use; mentoring; coaching; career patching; top talent management; track and report training (learning solution); and functional skills development (sales and marketing).

Service levels may be assigned to different core processes and functions. The service levels being indicative of levels or amounts of resources for performing core processes or functions. For example, consider services levels for talent development 66. A service level 1 may include basic team building through activities and foundational team essentials training. This service level of talent development may be focused on team producing at an acceptable level. It may include team events which are more social in nature and involve limited team effectiveness training and assessment. A service level 2 may include intermediate team building which includes service level 1 and also limited team effectiveness and working style assessment. It may be focused on teams producing at a raised bar level or in a team change environment. A service level 3 may describe service associated with advanced team building and may include service level 2 and also intense team effectiveness and working style assessments. It may be focused on teams producing in a raised bar and uncharted developmental area in a team change environment.

Performance management 68 is a core function which may include any number of associated processes. Examples of such processes may include: performance planning; performance review; performance assessment; performance coaching/correction; and, calibration (performance rating and merit compensation). Processes performance planning, performance review, and performance coaching/correction may have only one service level.

Employee relations 70 is a core function which may include processes such as employee relations and ethics, exit interviews; compliance, progressive discipline, and human resource policy development. Processes employee relations and ethics, exit interviews, compliance, and progressive discipline need only have one service level.

Organizational effectiveness 72 is a core function which may include processes such as: workforce classification; change management; human resource data and reporting; job management; position management; voice of employee surveys; and organizational design.

Benefits 74 is a core function which may include any number of processes. Compensation 76 is a core function which may include processes such as global job grading; administration, system, design and build; salary planning; annual compensation base pay optimization (return on investment of salary productivity metric); out-of-salary; and job evaluations.

Preventative health 78 is a core function which may include processes such as employee assistance programs (EAP), disability management, return to work, and; education. These processes may have only one service level.

Reward and recognition 80 is a core function. One example of a process associated with reward and recognition 80 may be service award administration and other non-cash programs.

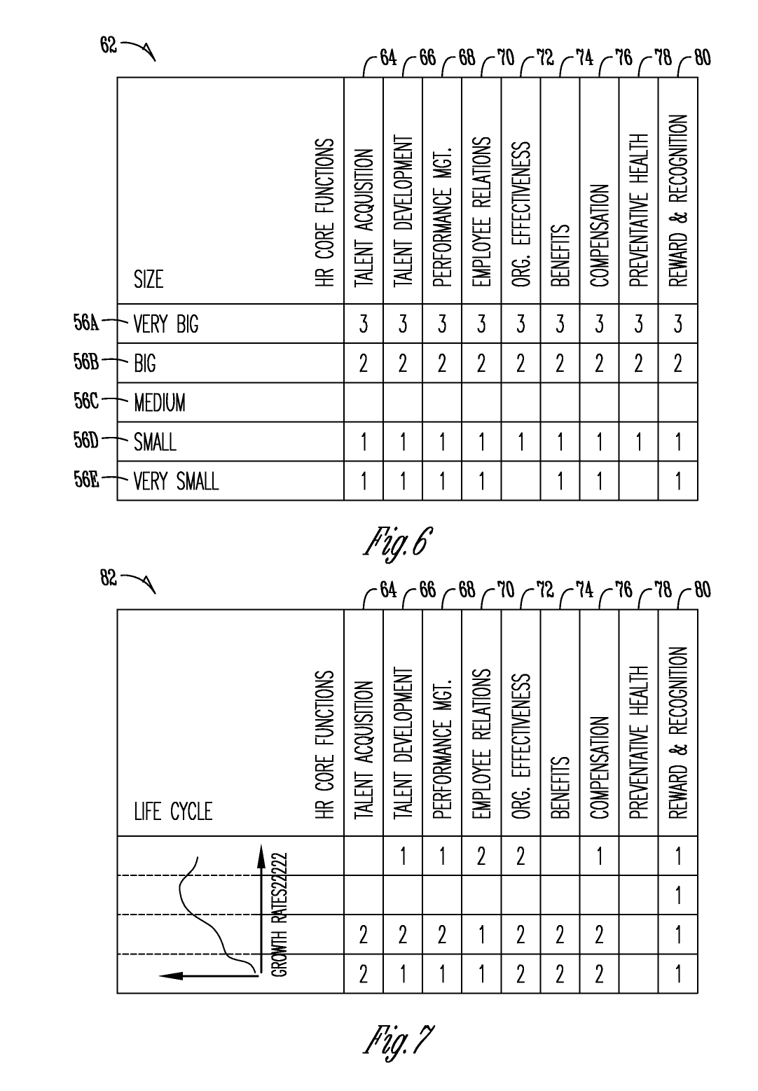

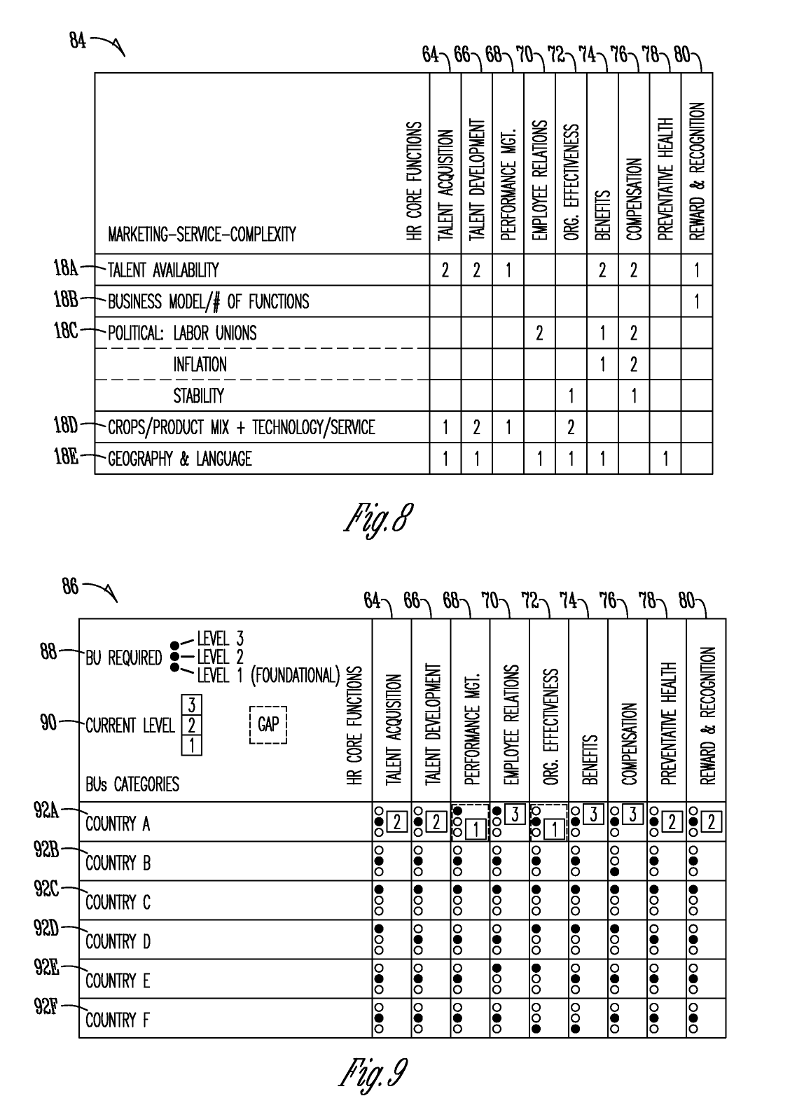

Different service levels may be assigned to different core functions and processes associated with human resources. FIGS. 6 and 7 illustrate how service levels may be defined for different business categories or business functions. FIG. 6 illustrates a table 62 which may be constructed within a software application which defines services level for different human resource core functions based on size. In FIG. 6, the sizes “very big” 56A, “big” 56B, “medium” 56C, “small” 56D, and “very small” 56E are related to talent acquisition 64, talent development 66, performance management 68, employee relations 70, organizational effectiveness 72, benefits 74, compensation 76, preventative health 78, and reward and recognition 80. Note that a service level between 1 and 3 is assigned for HR core functions based on size. In FIG. 7, table 82 defines service levels for different human resource functions for product life cycles.

FIG. 8 provides one example showing an impact matrix 84 which summarizes business unit complexity categories talent availability 18A, business model/number of functions 18B, political 18C, product mix 18D, and geography and language 18E to human resource core functions talent acquisition 64, talent development 66, performance management 68, employee relations 70, organization effectiveness 72, benefits 74, compensation 76, preventative health 78, and reward and recognition 80.

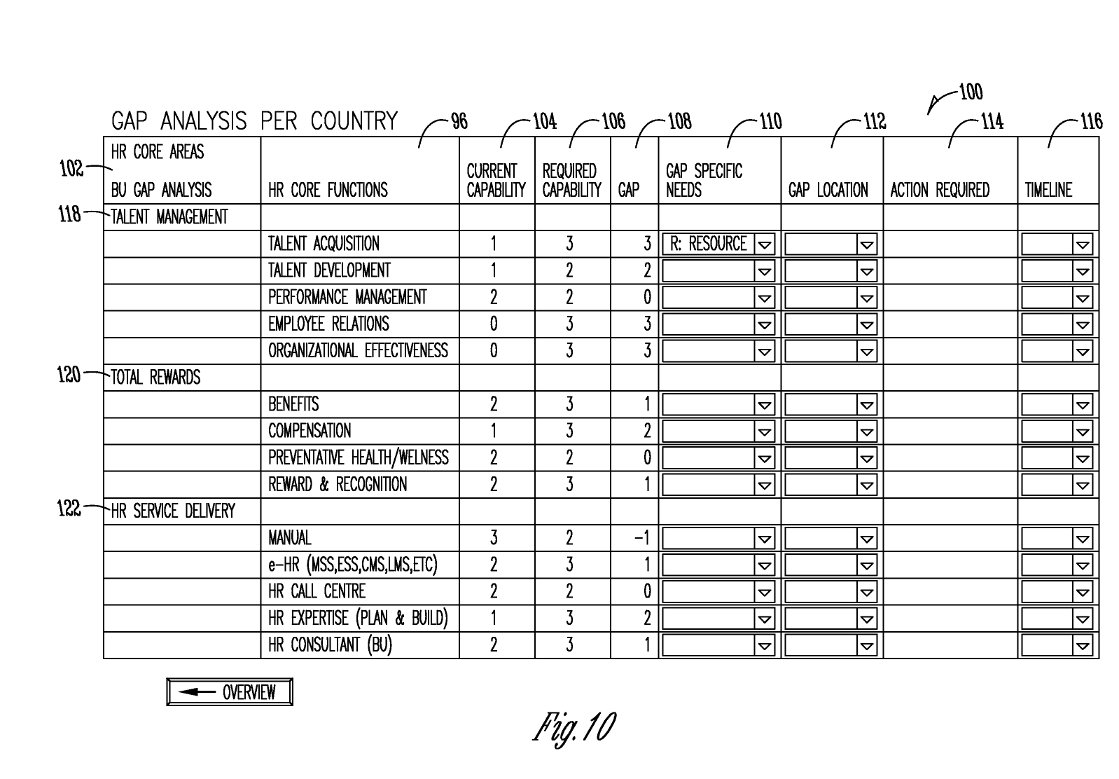

FIG. 9 illustrates an impact matrix 86 which summarizes relationships between different business unit categories country A-F (92A-92F) to human resource core functions talent acquisition 64, talent development 66, performance, management 68, employee relations 70, organization effectiveness 72, benefits 74, compensation 76, preventative health 78, and reward and recognition 80. Note that in the impact matrix shown in FIG. 9, both a required level as determined by the assignment of service levels as well as the current level are shown. FIG. 9 also indicates where gaps exist between the current level of service and the appropriate level of service for a particular business unit.

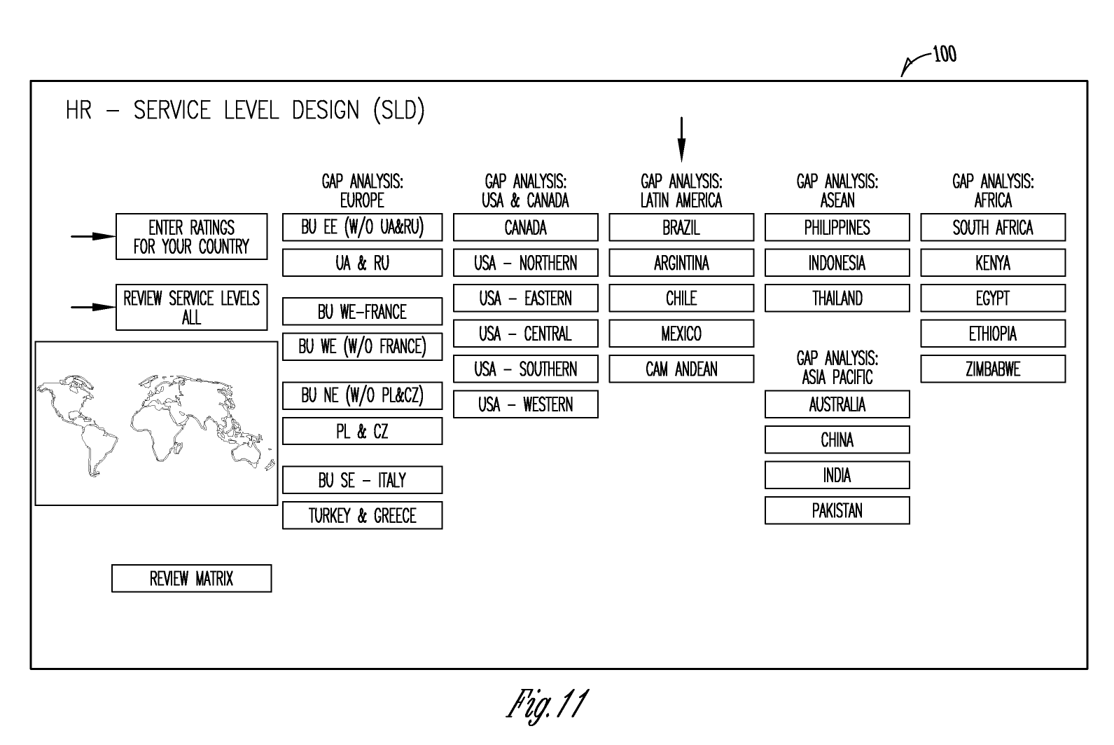

FIG. 10 illustrates a sample GAP analysis screen display 100 generated by the computer software application 12. The GAP analysis screen display 100 shown is for a gap analysis for a country for human resource core areas. Note that core areas 102 are shown in the left column. Examples of the core areas include talent management 118, total rewards 120, and human resource service delivery 122. To the right of the core areas 102 are the core functions 96, then current capability 104, required capability 106, gap 108, gap specific needs 110, gap location 112, action required 114, and timeline 116.

The gap specific needs 110 may be, for example and without limitation, capabilities (skills), resources (number of people), available tools, budget, and process. The gap location may be a location, country, or region.

The screen display 100 in FIG. 10 not only shows the gaps between currently capability and required capability, but also provides a numeric measure of the gap, so the size of the gap is quantified. In addition, the software application allows a user to indicate what the gap specific needs are, such as be selecting from a combo box or list. The software application also allows a user to select the gap location, specify action required, and provide a time line. Thus, the gap analysis may be used to manage resource allocation across an enterprise by first identifying what the gaps are and then how to address them.

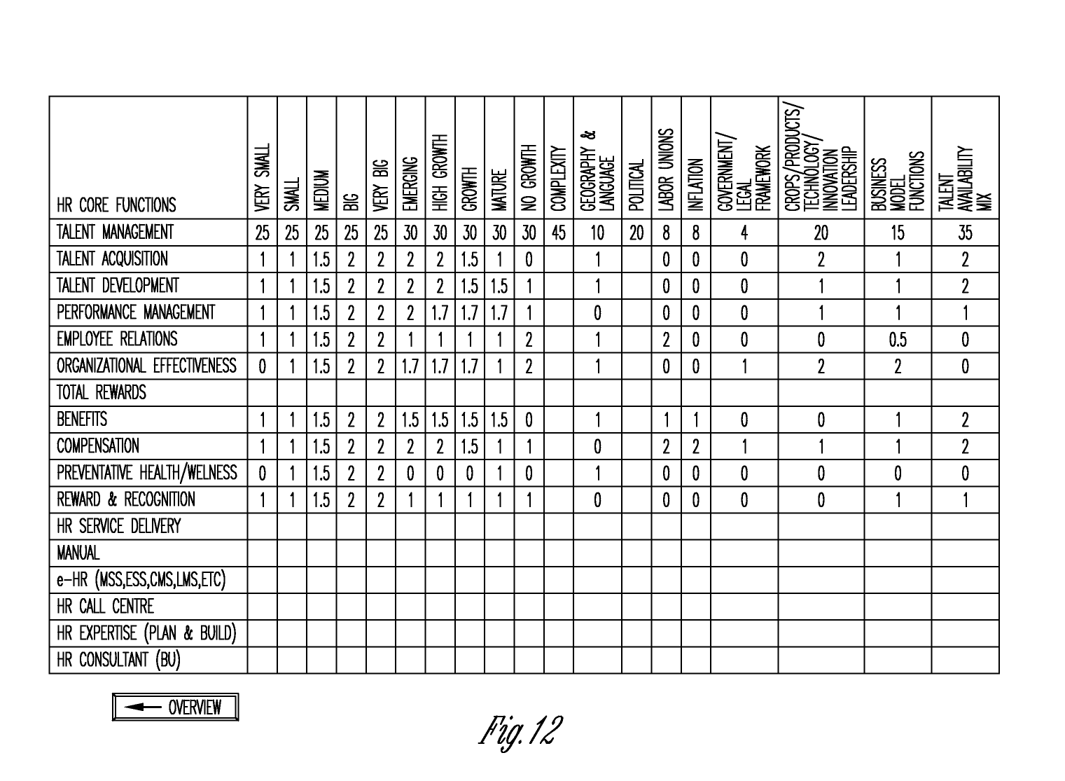

FIG. 11 illustrates a screen display from the software application which allows a user to select that they wish to enter ratings for their country, review service levels, or review a gap analysis.

FIG. 12 illustrates a screen display showing the impact of various business factors, including business size, business growth, and complexity on human resources core functions.

In operation, representatives from each business unit may provide data regarding their business unit directly into a computer software application or else such data may be obtained otherwise. The service levels may be defined by the group responsible for management of resources. The software application allows the impact matrix to be formed to relate the service levels to the business factors. The software application may also assist in analyzing the impact matrix, such as through gap analysis as well as suggesting or recording changes in resource allocation based on that analysis.

Although specific examples have been provided in the context of a plant science enterprise, numerous variations, alternatives, and options are contemplated. These include for example, the type of enterprise, variations in the number of business units, variations in the services matched to individual business needs, variations in the service level design, and other variations. It is to be further appreciated that although the methods and systems described herein are useful in the context of human resources, other business units within an enterprise may be similarly evaluated and managed.

What is claimed is:

1. A computer-assisted method for allocating resources across an enterprise to match needs for different business units across the enterprise, the method comprising:
defining business unit categories in a software system, each of the business unit categories including a plurality of business factors;
collecting data associated with the business factors;
defining the service levels in the software system;
forming an impact matrix to relate the service levels to the business factors;
analyzing the impact matrix using the software system to provide an analysis to assist in allocating resources, the software system being executed on a computer.

2. The method of claim 1 wherein the analysis is a gap analysis.

3. The method of claim 2 further comprising formulating at least one action to take based on the gap analysis.

4. The method of claim 3 further comprising formulating a timeline for taking the at least one action based on the gap analysis.

5. The method of claim 1 further comprising making a decision based on the analysis.

6. The method of claim 5 further comprising implementing the decision.

7. The method of claim 1 wherein the software system comprises one or more spreadsheets.

8. The method of claim 1 wherein the step of defining the service levels comprises applying a scoring system to the service levels for the business factors.

9. The method of claim 8 wherein the scoring system is a weighted scoring system.

10. The method of claim 1 wherein the business unit categories comprise market complexity, market size, and market life cycle.

11. The method of claim 10 wherein the business units operate in different regions.

12. The method of claim 10 wherein the business unit categories include market complexity and wherein the market complexity includes at least one of political instability, talent availability, complexity of product mix and innovation leadership.

13. The method of claim 1 wherein the resources being associated with Human Resources.

14. The method of claim 13 wherein the services levels being defined for Human Resources core functions.

15. The method of claim 14 wherein the Human Resources core functions include at least one of talent acquisition, talent development, performance management, employee relations, organizational effectiveness, benefits, compensation, preventative health, and reward or recognition.

16. The method of claim 1 wherein the data associated with the business factors includes financial data.

17. An article of software stored on a computer readable medium and adapted for being executed on a computer to assist in allocating resources across an enterprise, the article of software adapted for (1) defining business unit categories in a software system, each of the business unit categories including one or more business factors, (2) collecting data associated with the business factors, (3) defining service levels for the business factors, (4) forming an impact matrix to relate the service levels to the business factors, and (5) analyzing the impact matrix to provide an analysis to assist in allocating resources.

18. A computer-assisted method for allocating resources associated with Human Resources across an enterprise, the method comprising:
defining business unit categories associated with providing Human Resources to the enterprise, each of the business unit categories including one or more business factors;
wherein the business unit categories comprise at least one of market complexity, market size, and market life cycle;
collecting data associated with the business factors, wherein the data comprises financial data and employment data;
defining service levels in the software system for the business factors by applying a scoring system to the service levels for the business factors;
forming an impact matrix to relate the service levels to the business factors; and
analyzing the impact matrix using a software system to provide a gap analysis to assist in allocating the resources, the software system being executed on a computer.

19. The method of claim 18 wherein the software system comprises one or more spreadsheets.

20. The method of claim 18 wherein each of the business units operating in a different country.
